(19) United States
(12) Patent Application Publication
(10) Pub. No.: US 2026/0367380 A1
(43) Pub. Date: Nov. 19, 2026

(54) SYSTEM AND METHOD FOR PARALLELIZED ANGLED ILLUMINATION AND DETECTION

(71) Applicant: Ramona Optics Inc., Durham, NC (US)

(72) Inventors: Mark Harfouche, Durham, NC (US); Gregor Horstmeyer, Durham, NC (US); Aurélien Gauthier Florent Bègue, Durham, NC (US)

(73) Assignee: Ramona Optics Inc., Durham, NC (US)

(21) Appl. No.: 19/680,655

(22) Filed: May 18, 2026

Related U.S. Application Data
(60) Provisional application No. 63/806,874, filed on May 16, 2025.

(51) Int. Cl. G02B 21/16; G02B 21/06; G02B 21/26; G02B 21/36

(52) U.S. Cl. CPC G02B 21/16; G02B 21/06; G02B 21/26; G02B 21/361

(57) ABSTRACT

A system and method to achieve high-throughput 3D imaging of many specimens within well plates using parallelized light sheet illumination excitation and image data recording. A method is described for forming a parallel array of light sheets using reflective and/or refractive optics that can be integrated within the well plate itself. These sheets of light illuminate and/or excite unique specimen areas. A multi-camera array microscope system is then used to capture image data from the uniquely illuminated specimen areas in parallel. The end result is a system that can capture light sheet illuminated 3D specimen data from dozens or more specimens in parallel, which can dramatically speed up light sheet acquisition within high throughput microscopy contexts.

### CROSS-REFERENCE TO RELATED APPLICATIONS

This application claims the benefit under 35 U.S.C. § 119(e) of U.S. Provisional Patent Application No. 63/806,874, filed on May 16, 2026, entitled “SYSTEM AND METHOD FOR MULTI-CHANNEL FLUORESCENCE SURGICAL MICROSCOPY,” the entire contents of which are incorporated herein by reference.

### FIELD OF THE INVENTION

The present disclosure relates generally to microscopy and imaging technology and particularly, to a system and method to achieve high-throughput 3D imaging of many specimens within well plates using parallelized angled illumination excitation and image data recording.

### BACKGROUND OF THE INVENTION

Light sheet microscopy is a technique that illuminates a thick specimen with a thin sheet of light while recording the scattered or (more commonly) fluorescently excited light via a separate imaging path. By shifting the sheet of light with respect to the sample and capturing a sequence of images, it is possible to minimize out-of-plane fluorescence excitation and thus reconstruct accurate high-resolution, large-volume 3D imagery. In addition, as opposed to direct trans-illumination, light sheet excitation and general light sheet illumination can be configured in such a way that its illumination is at a large angle with respect to the imaging system, such that its illumination does not enter the imaging system unless a sample is present. In other words, imaging systems do not capture the direct beam from light sheet excitation and illumination, but instead only the associated fluorescence excitation or scattered response of the sample. This provides a key benefit in reducing background and improving image contrast in both fluorescence as well as standard imaging.

The field of light sheet imaging has a long history with many varied implementations (Stelzer, E.H.K., Strobl, F., Chang, BJ. et al. Light sheet fluorescence microscopy. Nat. Rev. Methods Primers 1, 73 (2021)), and it has found tremendous success for accurate large-volume 3D capture. Yet nearly all of the existing light sheet setups have used a single objective lens and image sensor for image capture. Thus, to perform light sheet imaging across many specimens, which is a common need in high content and high throughput experiments, for example within genetics, drug discovery and toxicology, one is effectively forced to capture data from each specimen, one at a time. This of course is a rather time-consuming endeavor, and innovation is needed to speed up the light sheet imaging process for high-throughput applications.

Several prior efforts have tried to improve the ability of light sheet microscopy to scale to capture many specimens. Maioli et al. presents a light sheet method that is compatible with scanning across 96-well plates (V. Maioli et al., Time-lapse 3-D measurements of a glucose biosensor in multicellular spheroids by light sheet fluorescence microscopy in commercial 96-well plates, Sci. Rep. 6, 37777 (2016)). Similarly, Moos et al. presents an open-top light sheet microscope design and associated scanning mechanism to time-sequentially scan more than one sample (Moos, F., Suppinger, S., de Medeiros, G. et al. Open-top multisample dual-view light-sheet microscope for live imaging of large multicellular systems. Nat. Methods 21, 798–803 (2024)). Unfortunately, these sample-by-sample scanning approaches take a long time (N times longer for N samples), and thus do not address the fundamental throughput problem associated with high-content imaging experiments.

Hamamatsu has introduced a scanning system that uses a single broad light sheet to cover an entire well plate (CYTOQUBE™, Hamamatsu Photonics K.K., Bridgewater, NJ). This new scanning system can rapidly image many samples at once, which is a goal of this invention. However, it does so at reduced resolution. It also does not accommodate imaging at different resolutions for different sized specimens.

Beghin et al. has introduced the use of mirrors embedded within well plates to enable light sheet illumination (Beghin, A., Grenci, G., Sahni, G. et al. Automated high-speed 3D imaging of organoid cultures with multi-scale phenotypic quantification. Nat. Methods 19, 881–892 (2022)). This work introduces optical components within the well plate itself.

There is an urgent need to overcome the various limitations of available systems with respect to high-throughput 3D imaging of many specimens within well plates.

### SUMMARY OF THE INVENTION

The present disclosure provides systems and methods for parallelized three-dimensional optical imaging of multiple specimens in a multi-well vessel. In one aspect, the system includes a plurality of illumination sources configured to simultaneously generate a plurality of planar illumination beams, a multi-well vessel configured to contain a plurality of specimens distributed across a plurality of wells, a multi-camera array microscope configured to simultaneously capture image data from multiple wells, and an image analysis system configured to reconstruct three-dimensional volumetric representations of the specimens in parallel.

In certain embodiments, each planar illumination beam is narrow in at least one spatial dimension relative to the field of view of a corresponding imaging unit of the multi-camera array microscope. The planar illumination beams may be directed toward respective specimen wells at an angle relative to an optical imaging axis. In this configuration, the direct illumination beam is prevented from entering the imaging path in the absence of a specimen, thereby reducing background and enabling optical sectioning suitable for three-dimensional imaging.

The illumination sources may include, without limitation, light emitting diodes, lasers, laser diodes, vertical cavity surface emitting lasers, incoherent thermal sources, optical fibers, fiber bundles, waveguides, or combinations thereof. In some embodiments, the illumination sources are arranged in a first plane and associated with beam-shaping optical elements arranged in a second plane. Each beam-shaping optical element may shape light from a corresponding illumination source into a planar illumination beam. Suitable beam-shaping elements may include cylindrical lenses, aspheric lenses, aperture masks, metalenses, diffractive optical elements, Bessel beam-forming elements, or combinations thereof.

The illumination sources and beam-shaping optical elements may be positioned in different spatial arrangements relative to the multi-well vessel and the multi-camera array microscope. In some embodiments, the illumination sources and beam-shaping optical elements are positioned on a first side of the multi-well vessel, while the multi-camera array microscope is positioned on an opposing second side of the vessel. In other embodiments, the illumination sources and beam-shaping optical elements are positioned on the same side of the multi-well vessel as the multi-camera array microscope. In such embodiments, the illumination sources and beam-shaping elements may be spatially interleaved with the imaging units of the microscope so as not to obstruct the imaging paths.

In certain embodiments, the multi-well vessel includes optical redirection elements integrated within, attached to, or otherwise associated with the vessel structure. The optical redirection elements may redirect the planar illumination beams toward respective specimen wells at an angle relative to the optical imaging axis. For example, reflective surfaces may be positioned adjacent to specimen-containing wells and oriented at an angle between about 15 degrees and about 75 degrees relative to the optical imaging axis. In some configurations, alternating rows or columns of the multi-well vessel are replaced by reflective surfaces, while the remaining rows or columns contain specimen wells. Each specimen well may thereby be associated with a reflective surface configured to redirect a planar illumination beam into the well from a direction substantially perpendicular to the optical imaging axis.

The optical redirection elements may be configured to improve illumination of particular specimen locations within the wells. In some embodiments, one or more optical redirection elements include curved reflective surfaces that direct planar illumination beams toward the bottom surface of a respective specimen well. This arrangement may improve illumination of specimens that settle, adhere, or aggregate near the well bottom. In other embodiments, one or more optical redirection elements incorporate spectral filters configured to selectively transmit or reflect light within one or more wavelength bands, including wavelength bands suitable for fluorescence excitation.

In further embodiments, two or more optical redirection elements may be positioned around a single specimen well. The optical redirection elements may direct planar illumination beams into the well from two or more directions simultaneously, improving illumination uniformity and reducing or overcoming scattering artifacts caused by the specimen. The multi-well vessel may also include refractive optical elements integrated within the vessel structure, lid, or other vessel component. Such refractive optical elements may further shape, focus, or condition each planar illumination beam before the beam enters the respective specimen well.

In one embodiment, each imaging unit of the multi-camera array microscope may be associated with a pair of reflective surfaces. A first reflective surface may redirect a planar illumination beam away from the imaging unit and upward into the specimen. A second reflective surface may include a dichroic element configured to transmit fluorescence emission toward the imaging unit while reflecting excitation light. In this manner, excitation light may be directed away from the imaging unit while fluorescence emission from the specimen is directed toward the imaging unit for detection.

The system may further include a scanning mechanism configured to laterally displace one or more planar illumination beams relative to the specimen wells. Such lateral displacement may enable axial scanning of each planar illumination beam through its respective specimen, allowing three-dimensional image stack acquisition. The scanning mechanism may include lateral displacement of the illumination sources, lateral displacement of the beam-shaping optical elements, axial displacement of the multi-camera array microscope, axial displacement of the multi-well vessel, dynamic refocusing of individual imaging unit lenses within the multi-camera array microscope, or combinations of these approaches. In some embodiments, axial refocusing of one or more imaging units is performed synchronously with lateral scanning of the associated planar illumination beam, such that the illuminated focal plane remains in focus throughout the scan.

One or more imaging units of the multi-camera array microscope may include fluorescence emission filters configured to selectively detect fluorescence excited by the planar illumination beams while rejecting excitation wavelengths. The multi-well vessel may conform to Society for Biomolecular Sciences standard exterior dimensions and may include, for example, 12, 24, 48, 96, 384, or 1536 wells.

The image analysis system may process image data captured by the multi-camera array microscope to generate three-dimensional volumetric representations of multiple specimens in a parallelized manner. In some embodiments, the image analysis system registers three-dimensional image stacks acquired by different imaging units, applies digital calibration to correct for physical differences among the imaging units and their associated planar illumination beams, and performs image processing on the registered and calibrated stacks. Such processing may include deconvolution, segmentation, semantic segmentation, feature detection, three-dimensional tracking, or combinations thereof. In certain embodiments, the parallelized image processing is executed on one or more graphical processing units.

The specimens imaged by the disclosed system may include biological specimens such as adherent cells, cell monolayers, cellular spheroids, organoids, embryos, small model organisms, or combinations thereof. The disclosed system thereby enables high-throughput, parallelized, three-dimensional optical imaging of multiple specimens in a multi-well format, including fluorescence imaging and volumetric reconstruction across many wells substantially simultaneously.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF DRAWINGS

Having thus described the subject matter of the present invention in general terms, reference will now be made to the accompanying drawings, which are not necessarily drawn to scale, and wherein:

FIG. 1 is a schematic side view of a lens-and-mirror light sheet configuration. Cylindrical lenses form planar illumination beams that are redirected by mirrors into wells of a well plate, with lateral scanning of the beams providing axial scanning of specimens.

FIG. 2 is a schematic side view of an epi lens-and-mirror light sheet configuration. The illumination optics and imaging optics are positioned on the same side of the well plate, and scanned planar beams are redirected into respective wells.

FIG. 3 is a schematic side view of another lens-and-mirror light sheet configuration. The multi-camera array microscope and light sheet optics are positioned on opposing sides of the well plate in an inverted arrangement relative to FIG. 1.

FIG. 4 is a schematic side view of another epi lens-and-mirror light sheet configuration. The illumination optics and imaging optics are arranged on a common side of the well plate in an inverted orientation relative to FIG. 2.

FIG. 5 illustrates scan-offset illumination source configurations for forming angled planar illumination beams. Offset sources and cylindrical lenses direct scanned light sheets into wells while imaging optics capture emitted or scattered light.

FIG. 6 illustrates a prism-based tilted sheet formation configuration. A prism or other beam-tilting element redirects a planar illumination beam into a specimen well at an angle relative to the imaging axis.

FIG. 7 is a schematic side view of a lens-and-curved-mirror light sheet configuration. A curved reflective element redirects the planar illumination beam toward the bottom of a well to improve illumination of bottom-localized specimens.

FIG. 8 is a schematic side view of an epi lens-and-curved-mirror light sheet configuration. The illumination and imaging optics are positioned on the same side of the well plate, and a curved mirror redirects scanned light sheets into the well.

FIG. 9 is a schematic side view of a light sheet configuration including additional lensing on top of the well plate. A refractive element associated with the well plate further shapes or focuses the planar illumination beam before entry into a specimen well.

FIG. 10 is a top schematic view of mirrors positioned on multiple sides of a well. The mirrors direct illumination into the well from multiple directions to improve illumination uniformity and reduce scattering artifacts.

FIG. 11 is a top schematic view of example mirror layouts for a modified 96-well plate. Selected rows, columns, or regions of the plate include reflective surfaces for redirecting light sheets into adjacent specimen wells.

FIG. 12 is a top schematic view of example double-mirror layouts for a modified 96-well plate. Paired reflective surfaces redirect excitation light into specimen wells while permitting emitted or scattered light to be collected by corresponding imaging units.

### DETAILED DESCRIPTION OF THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

The present invention brings light sheet microscopy methods into high-throughput and high-content experimental contexts. Due to the need to image many individual specimens within these contexts, existing light sheet microscopes that use a single objective lens are first too slow for many scenarios. Thus, they are rarely used. Second, existing light sheet microscopes are generally not designed to accommodate specimens in multi-well plates, which are routinely used in high-throughput and high-content areas. This invention jointly speeds up and also optimizes light sheet illumination for high-throughput and high-content imaging scenarios to make light sheet microscopy possible in many new experiments.

As described more fully below, the present invention is directed to a system and method to achieve high-throughput 3D imaging of many specimens within well plates using parallelized light sheet illumination excitation and image data recording, which involves four interacting components: 1) a method to generate and scan thin light sheets; 2) a unique well plate design that can direct the light sheets to the specimens of interest; a multi-camera array to detect the resulting scattered or fluorescently excited light from the specimens of interest; and 4) co-designed image analysis software to process acquired data into final specimen reconstructions that contain high-fidelity 3D measurements. Additional details about each of these components is provided below.

### Light Sheet Generation and Scanning

The present invention uniquely proposes the generation of multiple (6, 12, 24, 48, 96 or more) individual light sheets in a simultaneous manner. This is unlike existing light sheet generation methods, which almost exclusively create a single light sheet. To generate multiple light sheets, this invention proposes the integration of multiple light sources within a first plane, and then multiple cylindrical lens sets within a second plane. The multiple light sources within a first plane can be comprised of an array of compact light emitting diodes, lasers, vertical cavity surface emitting lasers, fibers, or waveguides that carry light. In the case of using fibers that carry light to form the multiple light sources within a first plane, the fibers can be components of a fiber bundle, which is illuminated via one or more external light emitting diodes, lasers, vertical cavity surface emitting lasers, or other forms of standard light source. The fiber bundle’s individual fibers can be directed to the desired locations within the first plane via optomechanical mounts. In another preferred embodiment of using waveguides, light can be coupled into one or more initial waveguides from one or more external light emitting diodes, lasers, vertical cavity surface emitting lasers, or other forms of standard light source. Individual waveguides can then be split off from the initial waveguides to effectively form the multiple light sources within the first plane.

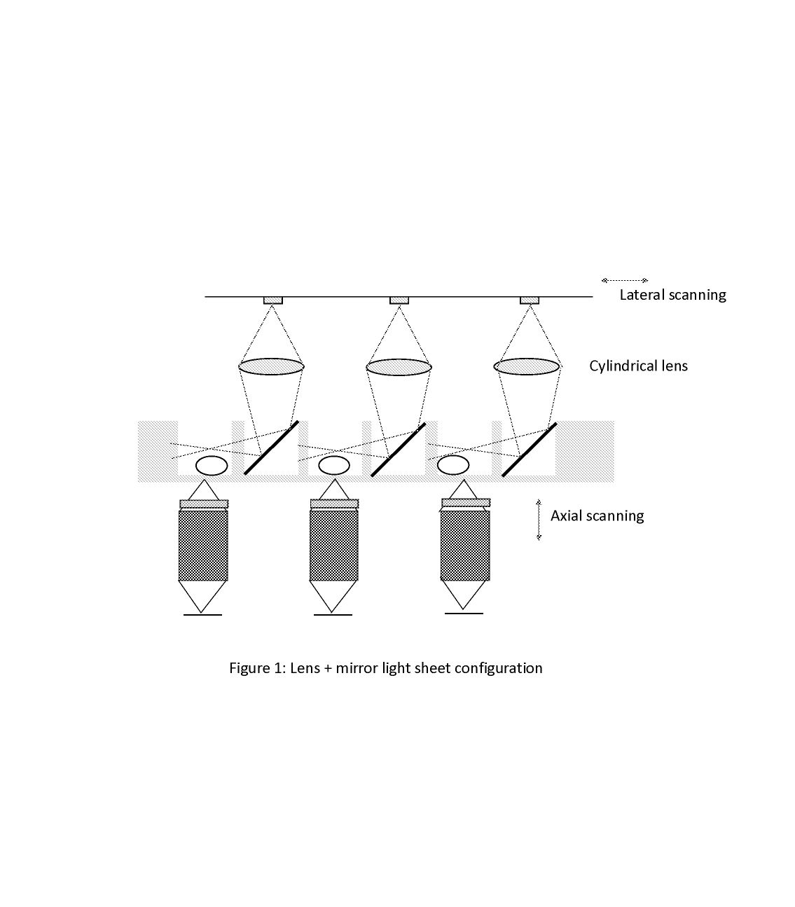

In one preferred embodiment, the light sources within a first plane and the cylindrical lens sets within a second plane are located above a multi-well plate (FIG. 1). In this embodiment, the sources within a first plane can each direct light downwards. The light from each source will be shaped by the cylindrical lens sets into a sheet-like beam that are directed to the well plate. Custom-designed lenses with unique aspheric shapes, aperture masks, metalenses, or other diffractive elements may be used to create specific sheet beam profiles that improve sheet quality (e.g., narrowness). For example, a Bessel beam-type mask may be included within each cylindrical lens set to increase the narrowness of the light sheet beam. In this preferred embodiment, the multi-camera array microscope (MCAM) is positioned beneath the well plate.

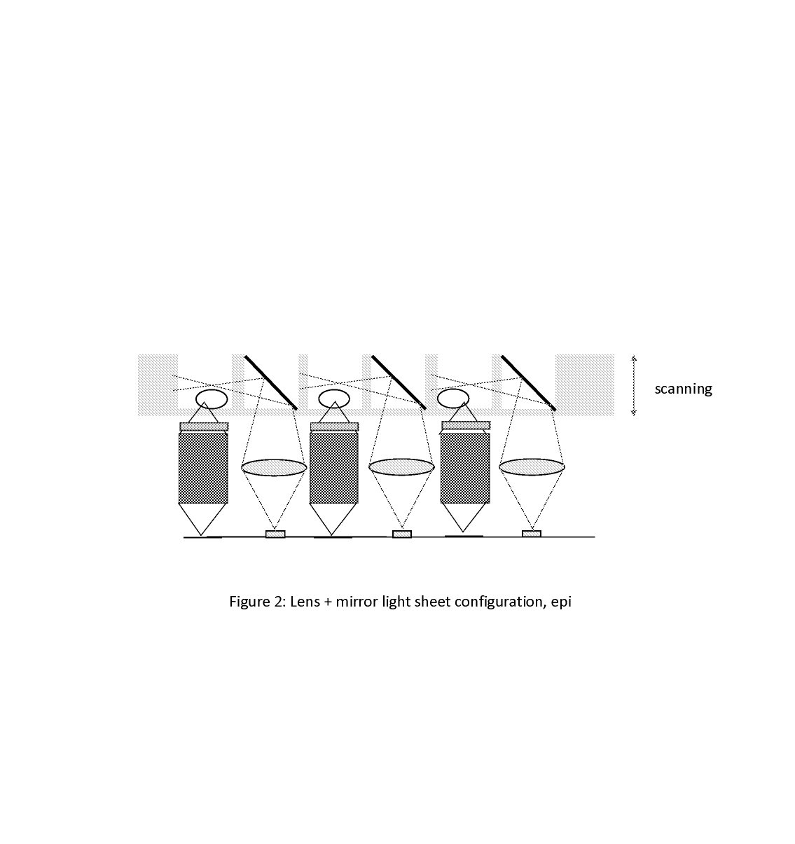

In a second preferred embodiment, the light sources within a first plane and the cylindrical lens sets within a second plane are located below a multi-well plate, on the same side as the MCAM (FIG. 2). In this configuration, care must be taken to interweave the light sources within a first plane and the cylindrical lens sets within a second plane such that they do not block or obscure the imaging paths of the MCAM optics. In this preferred embodiment, the light sources and cylindrical lenses may also contain or embody the various different features outlined in the paragraph above.

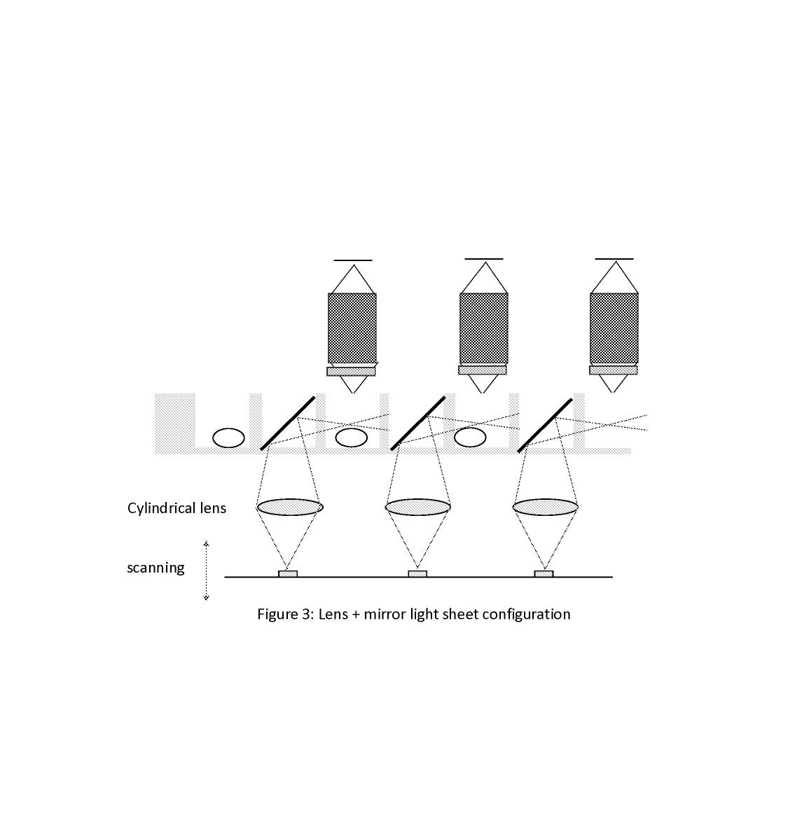

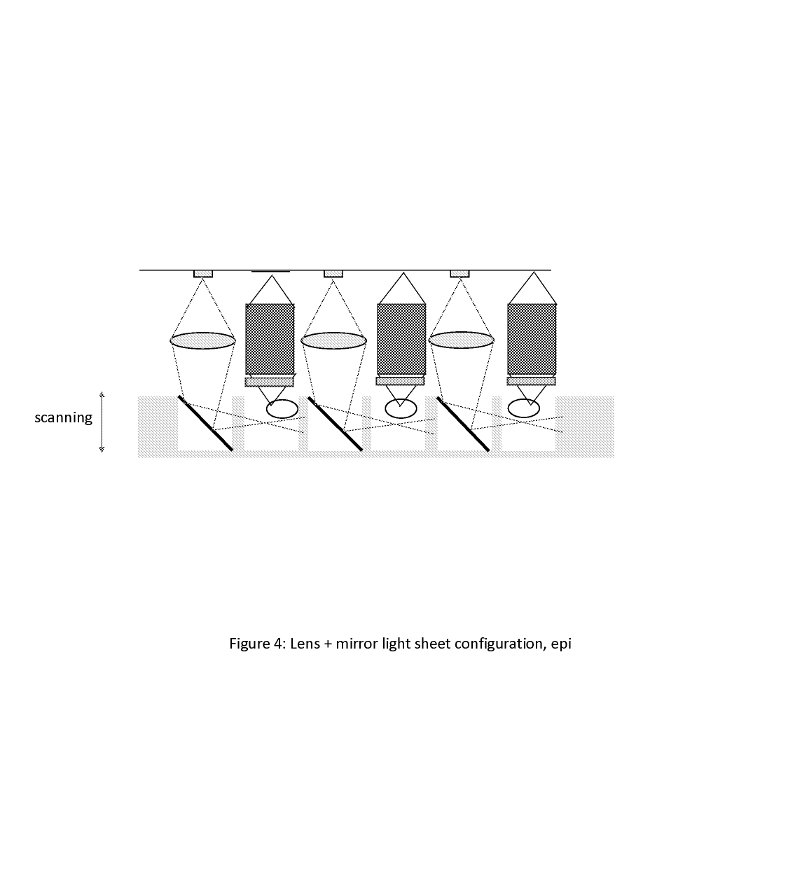

In a third preferred embodiment, the MCAM and light sheet optics may be the same in the first preferred embodiment, but flipped with respect to the well plate, such that the imaging optics are above the well plate and the light sheet optics below (FIG. 3). In a fourth preferred embodiment, the MCAM and light sheet optics may be the same as the second preferred embodiment but positioned above the well plate (FIG. 4).

### Light Sheet Re-Direction Via Well Plate-Integrated Optics

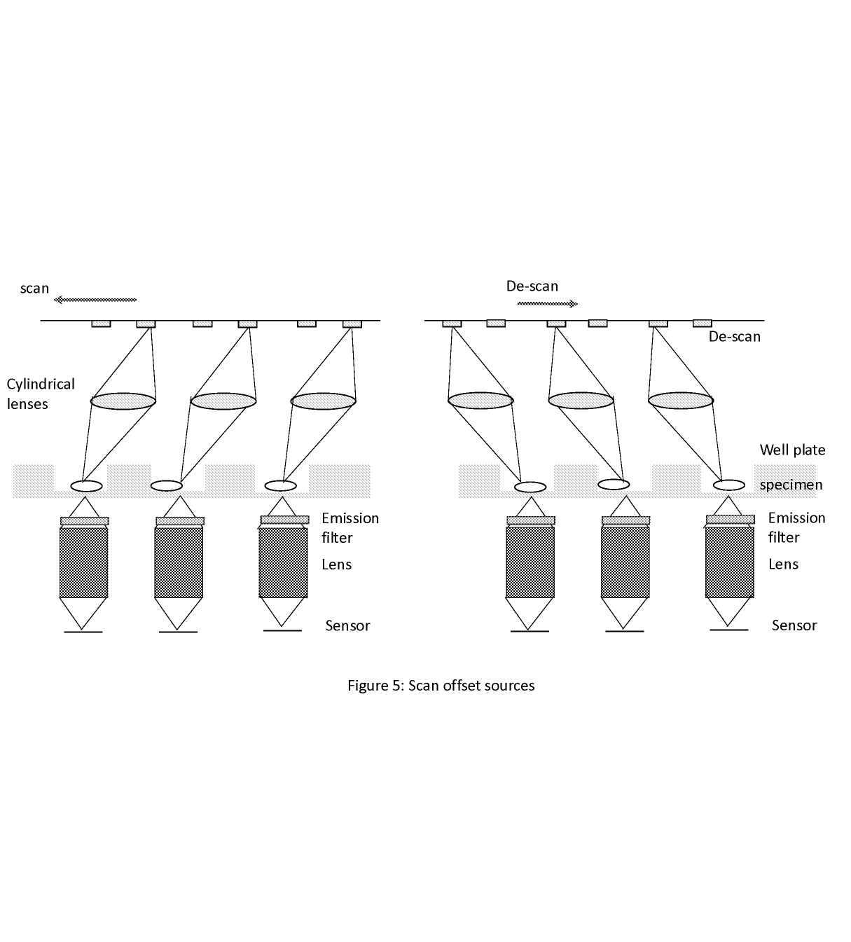

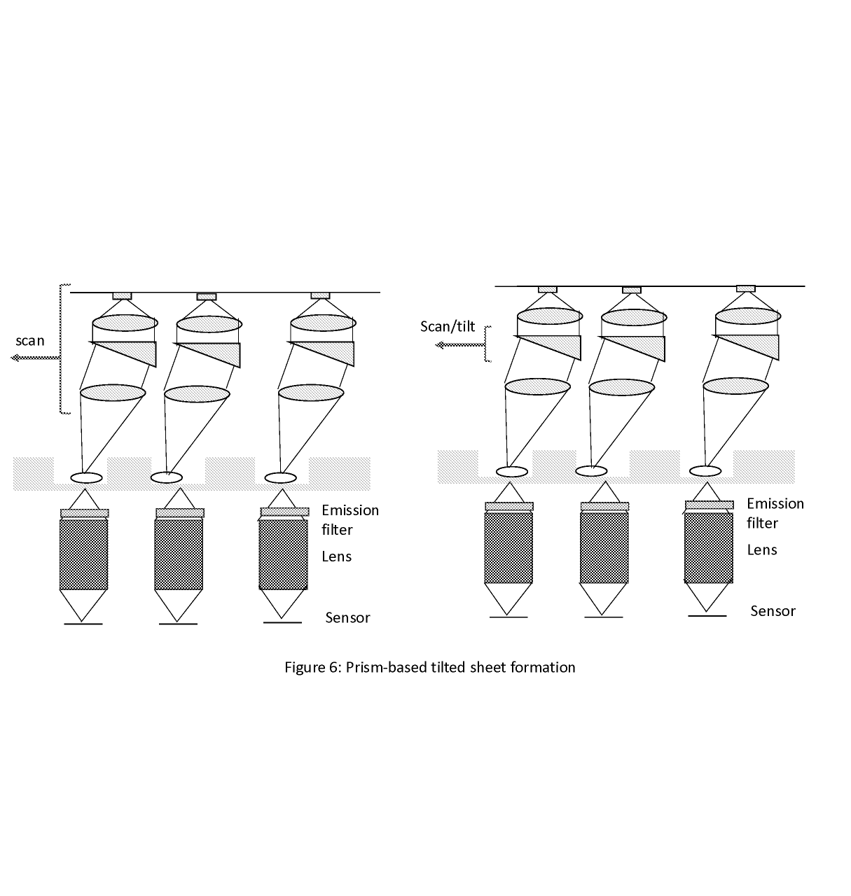

Light from the more than one sheets that is directed to the well plate can then interact with a customized well plate design that can include reflective and/or refractive optics. In one embodiment, the well plate can include no additional optics, and the light sheets can directly enter the wells from an inclined angle with respect to the optical axis. Additional optical elements such as prisms or offset mirrors may be added to or near the second plane that contains the cylindrical lens sets to create an angled light sheet (FIG. 5-6). While a benefit of this approach is that it is compatible with existing well plates that do not need any modification, a downside is that it is challenging to achieve a highly angled light sheet (i.e., a sheet that enters a well at a large angle with respect to the optical imaging axis).

To overcome this limitation, reflective and/or refractive optics may be added to (i.e., integrated within) the well plate structure. In one preferred embodiment, small, angled mirrors are placed next to wells of interest such that these more than mirrors each direct a light sheet towards one well of interest. This allows a given light sheet to enter a well from a large angle with respect to the optical axis. In such a configuration, lateral scanning of each light sheet’s optical source within the first plane of light sources, and/or lateral scanning of each light sheet’s cylindrical lens optics within the second plane, will allow for axial scanning of the more than one light sheets within the more than one well plate wells. Lateral scanning of each light sheet can be accompanied by axial re-focusing of the associated imaging objective lens that is viewing the area intersected by the reflected light sheet to sweep out a light sheet focal volume.

In one preferred embodiment, every other row or column of a 96 well plate is replaced with a tilted mirror or beam-splitter that can reflect light at a 90-degree angle with respect to the optical axis (i.e., the reflective surface is at a 45-degree angle with respect to the optical axis). The remaining rows or columns of wells contain specimens of interest, which the mirror directs the more than one light sheets towards, while the more than one microscope imaging units are positioned below each sample (FIG. 1). In a related preferred embodiment, the same plate may be used with the light sheet sources located below the sample and the imaging units located above the sample (see FIG. 3). In a related preferred embodiment, each reflective surface is at an angle between 15 and 75 degrees with respect to the optical axis (i.e., does not have to be exactly 45 degrees). A similar mirrored plate may also be used in the preferred embodiments where the light sheet sources are located on the same side of the well plate as the multi-camera array (see FIG. 2 and FIG. 4). In any of the above configurations, the mirrors can be flipped to direct light either to the left, or to the right, or in two dimensions to the top or the bottom of the muti-well plate.

In a second preferred embodiment, every other row or column of a 12, 24, 48, 96, 384, or 1536 well plate is replaced with a tilted mirror or beam-splitter that can reflect light at an angle with respect to the optical axis (between 15 and 165 degrees). That is, the same mirroring principle can be applied to multi-well plates of a variety of well numbers and well sizes and well pitches.

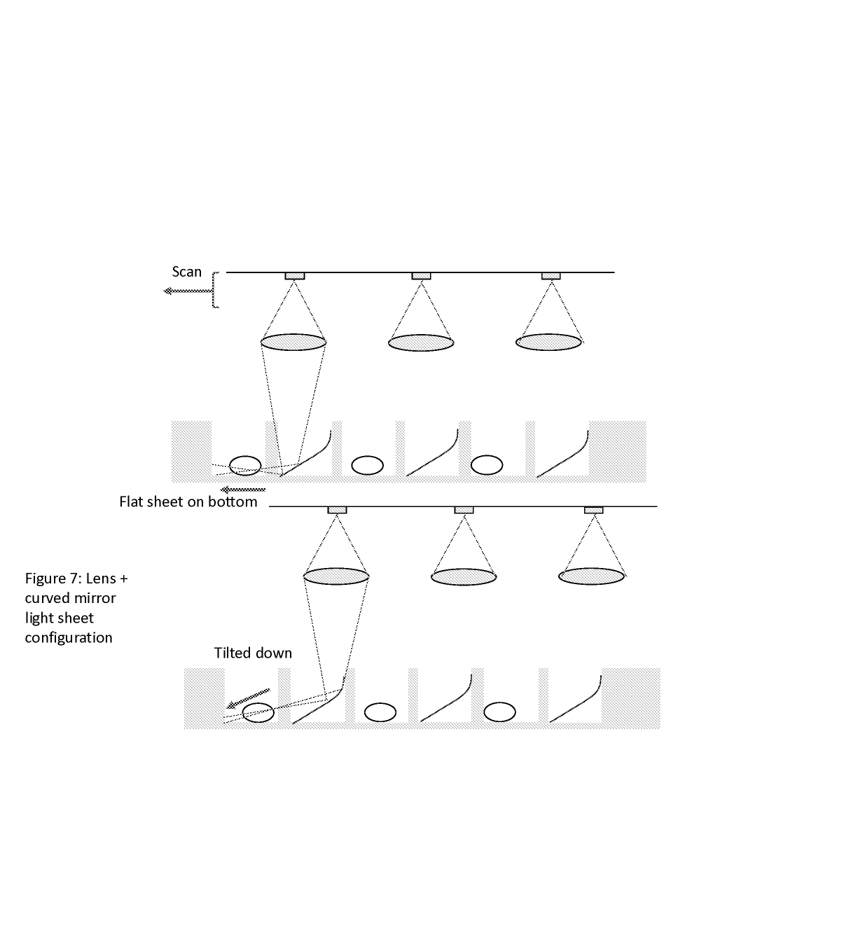

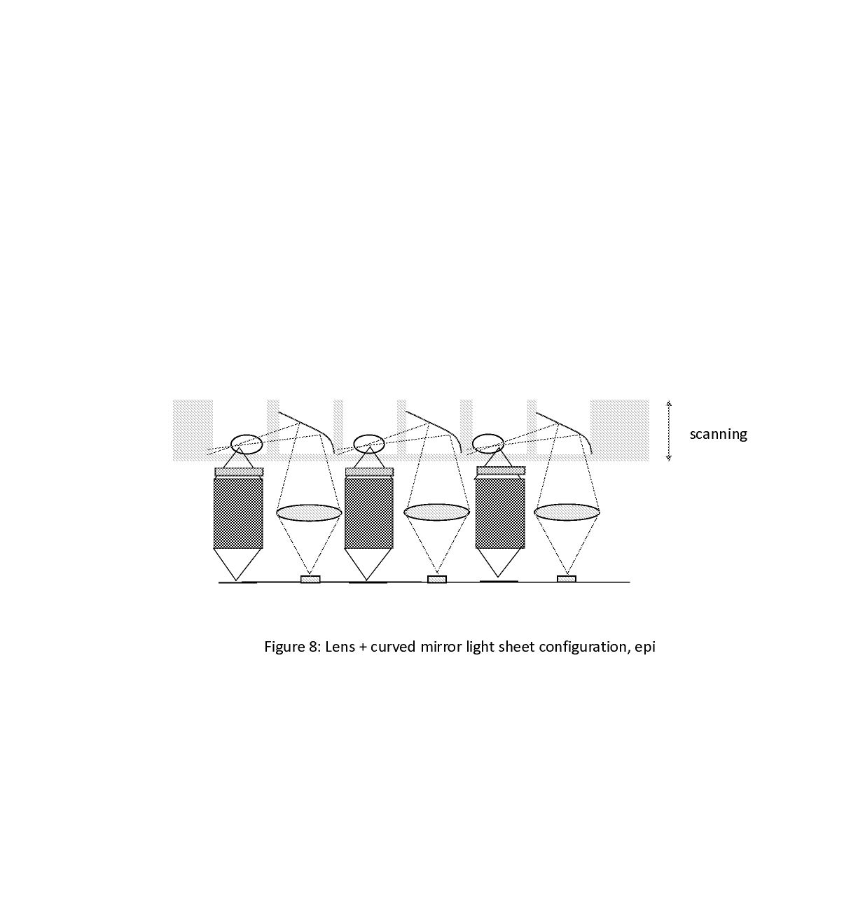

In some preferred embodiments, the mirrors or other reflecting optical elements do not need to be flat, but can instead be curved. This curvature may be used when the light sheet illumination sources are on opposites sides of the well plate from the micro-camera array (FIG. 7), or on the same side (FIG. 8). The benefit of a curved mirror surface is that it allows the light sheet to more effectively reach the bottom of the well plate during the light sheet scanning process, as most samples such as cellular material, spheroids, organoids, or small model organisms will tend to exist and/or aggregate at the bottom of the well plate. The curved mirror or other reflecting element can be used in combination with any of the above features (e.g., filters, additional optics) to enhance performance.

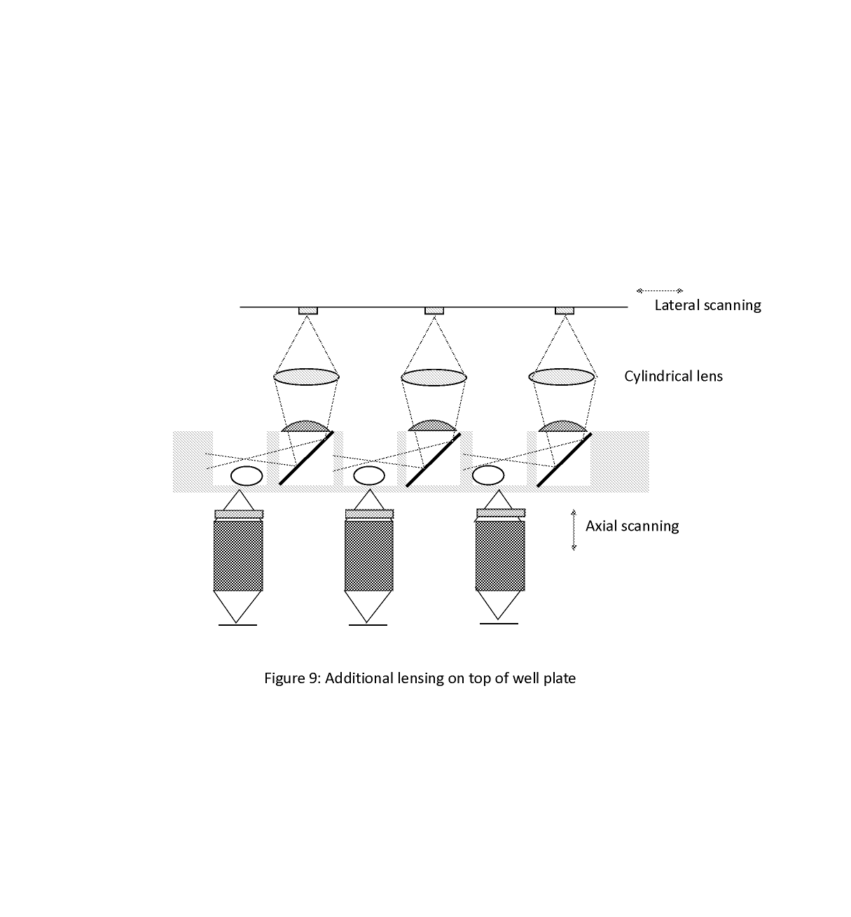

In some preferred embodiments, the mirrors or beam-splitters can include spectral filters for fluorescence excitation. In some preferred embodiments, the mirrors or beam splitters may be accompanied by other reflective or refractive optics. As diagrammed in FIG. 9, in one preferred embodiment, additional refractive optics may be included within the well plate structure, such as placing a refractive focusing element such as a cylindrical lens on the well plate lid, or attached to the additionally included mirror surfaces, which can enhance the quality of the more than one generated light sheets.

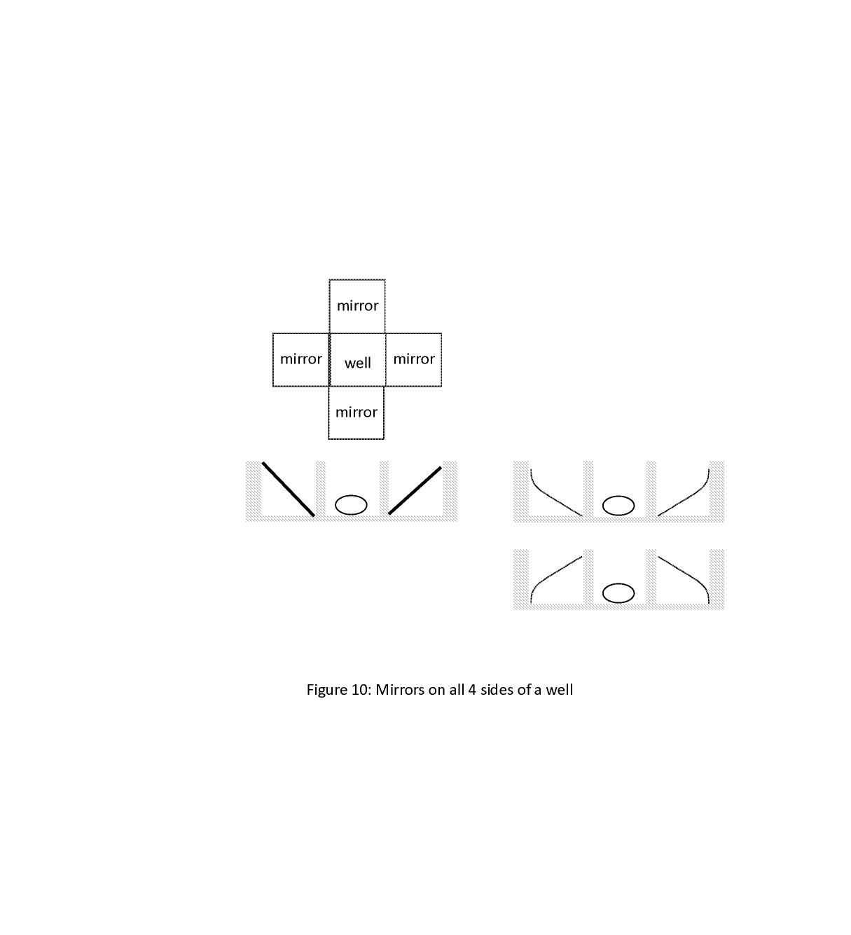

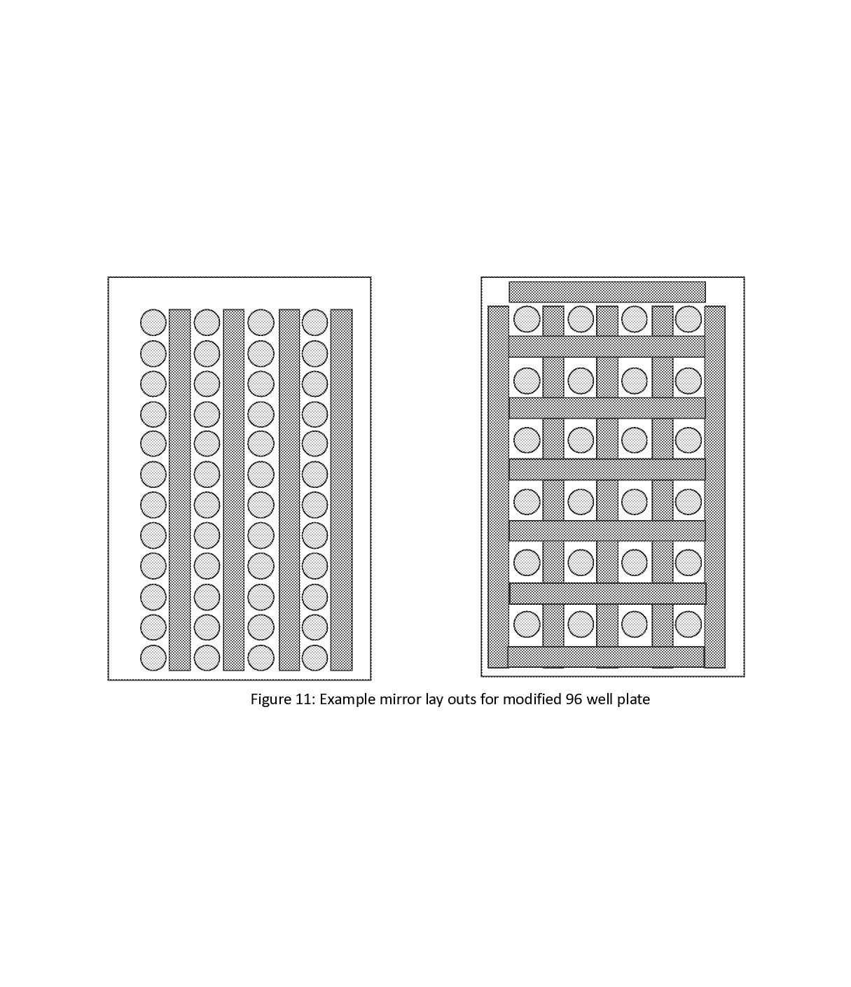

This invention may also use more than one reflective element to direct light to a given well within the well plate. As diagrammed in FIG. 10, 2 or 4 reflective surfaces may be placed around a given well to direct one or more light sheet beams into the well. The benefit of including more than one mirror allows one to use a light sheet to excite a sample from more than one direction, which can help overcome issues with light sheet quality due to scattering within the sample, and/or can speed up the acquisition process. Example layouts of mirrors from a top view are shown in FIG. 11.

### Double Mirror Design

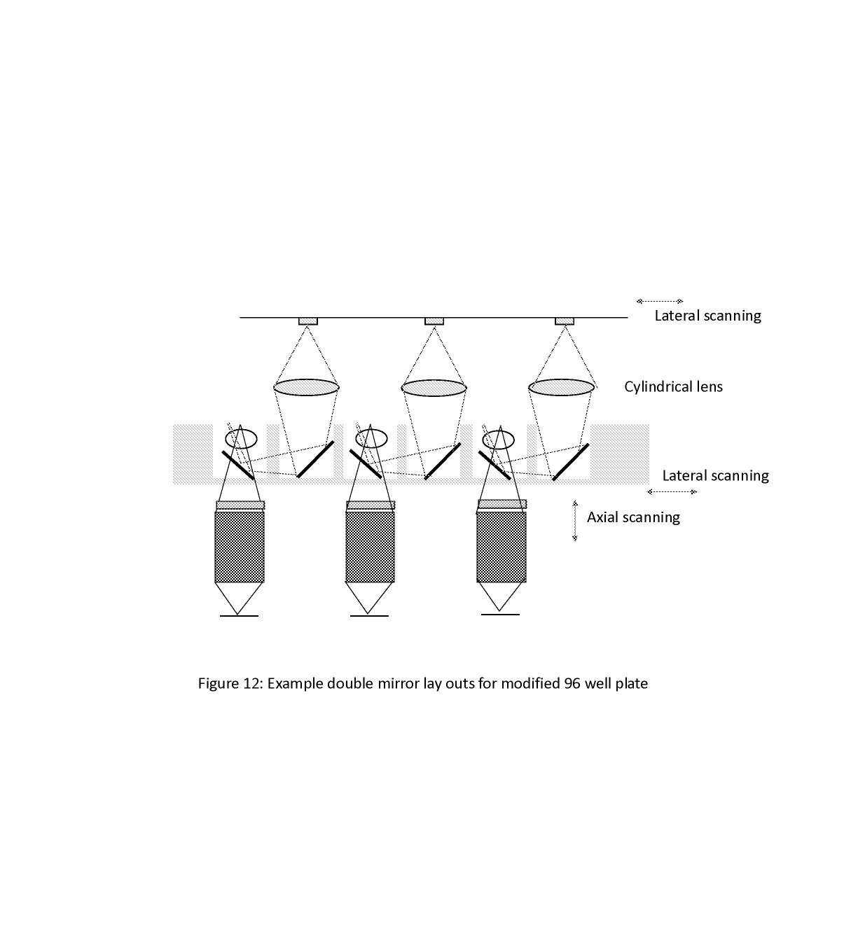

In another preferred embodiment diagrammed in FIG. 12, each imaging system within the array can utilize two angled reflective surfaces to direct light from an array of illumination sources located above the well plate, which shines light downwards to the multi-camera array for imaging, to instead travel upwards into the sample (i.e., away from the micro-camera array and back towards the illumination source. A key benefit of such an approach is that it allows one to illuminate or excite the bottom surface of each specimen of interest. If specimens are large and/or highly absorptive, such a strategy can allow for the micro-cameras located beneath each well to get a clear and high-quality image of the specimen bottom surface. A second key benefit is in the case of fluorescence imaging, the excitation light is directed away from each micro-camera. In one preferred embodiment, the first reflective surface can take the form of a mirror, while the second reflective surface can take the form of a dichroic plate or dichroic beamsplitter, which can enable fluorescence imaging. As with the previously noted embodiments, lateral and axial scanning of either the plate or the micro-camera array and illumination unit while more than one image is captured by one or more micro-cameras can facilitate effect 3D imaging across more than one well of an well plate in a synchronous manner.

### Multi-Camera Array Detection

A multi-camera array microscope (MCAM), as described in previous work, is then used to detect imagery across more than one well of the multi-well plate during parallelized light sheet scanning of the more than one generated light sheets. In one preferred embodiment, the multiple cameras or microscopes comprising the multi-camera array are outfitted with one or more fluorescence emission filters, such that one or more of the multiple cameras can capture the fluorescence excited by the associated light sheet passing across its field-of-view. In a second preferred embodiment, the MCAM does not include fluorescence filters and instead directly detects scattered light from the generated light sheets, which can enhance bright field image contrast.

To maintain the area of the sample that is targeted by the scanning light sheet in-focus, the MCAM can be axially scanned in synchronicity with the light sheet scanning. Alternatively or additionally, the well plate can be scanned axially to maintain focus. Alternatively or additionally, focusing elements can be included within the MCAM (e.g., auto-focus modules such as voice-coil motors) and can be used to refocus one or more micro-camera lenses to maintain appropriate focusing.

### Parallelized Image Analysis Software

After the present invention captures image snapshots from one or more micro- cameras examining the locations of the one or more light sheets illuminating the multi-well plate, a 3D light sheet stack can be formed for each micro-camera. One or more 3D light sheet stacks can then be post-processed to extract 3D volumetric imaging about thick specimens of interest. Post-processing includes steps such as 3D light sheet stack registration, deconvolution, cropping, feature detection, segmentation, semantic segmentation, and 3D tracking. Due to the parallelization of light sheets and image detection modules in this invention, post-processing is an important joint feature in this invention, due to the slight physical differences that will inevitably arise across the acquired data.

Specifically, this invention will use digital calibration of the more than one 3D light sheet stacks to account for such slight physical differences that can impact 3D measurement quality. Most critically, this invention can post-process more than one 3D light sheet stacks in a parallel manner, which is required to achieve rapid and effective post-processing from our parallelized light sheet capture system. In one preferred embodiment, parallelized processing can be achieved with a graphical processing unit.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present disclosure. For example, the term “about,” when referring to a value can be meant to encompass variations of, in some embodiments ± 100%, in some embodiments ± 50%, in some embodiments ± 20%, in some embodiments ± 10%, in some embodiments ± 5%, in some embodiments ± 1%, in some embodiments ± 0.5%, and in some embodiments ± 0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

The foregoing description and accompanying figures illustrate the principles, embodiments and modes of operation of the disclosure. However, the disclosure should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the disclosure as defined by the following claims.

1. A system for parallelized three-dimensional optical imaging of a plurality of specimens, the system comprising:
(a) a plurality of illumination sources configured to simultaneously generate a plurality of planar illumination beams, each planar illumination beam being narrow in at least one spatial dimension relative to the field of view of a coupled imaging unit and directed toward a specimen at an angle with respect to an optical imaging axis, such that the direct beam does not enter the imaging path in the absence of a specimen;
(b) a multi-well vessel configured to contain a plurality of specimens distributed across a plurality of wells;
(c) a multi-camera array microscope comprising a plurality of imaging units configured to simultaneously capture image data from a plurality of wells of the multi-well vessel illuminated by the plurality of planar illumination beams; and
(d) an image analysis system configured to process image data captured by the multi-camera array microscope to reconstruct three-dimensional volumetric representations of the plurality of specimens in a parallelized manner.

2. The system of claim 1, wherein each planar illumination beam is generated by an illumination source selected from the group consisting of: a light emitting diode, a laser, a laser diode, a vertical cavity surface emitting laser, an incoherent thermal source, an optical fiber, a fiber bundle, and a waveguide.

3. The system of claim 1, wherein the plurality of illumination sources are arranged within a first plane, and wherein the system further comprises a plurality of beam-shaping optical elements arranged within a second plane, each beam-shaping optical element associated with one illumination source and configured to shape the output of that source into a planar illumination beam, wherein the beam-shaping optical elements comprise one or more of: cylindrical lenses, aspheric lenses, aperture masks, metalenses, diffractive elements, and Bessel beam-forming elements.

4. The system of claim 3, wherein the plurality of illumination sources and the plurality of beam-shaping optical elements are positioned on a first side of the multi-well vessel and the multi-camera array microscope is positioned on the opposing second side of the multi-well vessel.

5. The system of claim 3, wherein the plurality of illumination sources and the plurality of beam-shaping optical elements are positioned on the same side of the multi-well vessel as the multi-camera array microscope, and wherein the illumination sources and beam-shaping elements are spatially interleaved with the imaging units of the multi-camera array microscope so as not to obstruct the imaging paths thereof.

6. The system of claim 1, wherein the multi-well vessel comprises one or more optical redirection elements integrated within or attached to the vessel structure, the optical redirection elements configured to redirect each of the plurality of planar illumination beams toward a respective specimen well at an angle with respect to the optical imaging axis.

7. The system of claim 6, wherein the optical redirection elements comprise reflective surfaces positioned adjacent to specimen-containing wells, and wherein each reflective surface is oriented at an angle between 15 and 75 degrees with respect to the optical imaging axis.

8. The system of claim 7, wherein alternating rows or columns of the multi-well vessel are replaced by reflective surfaces, and wherein the remaining rows or columns contain specimen wells, each specimen well having an associated reflective surface configured to redirect a planar illumination beam into that well from a direction substantially perpendicular to the optical imaging axis.

9. The system of claim 6, wherein one or more of the optical redirection elements comprise curved reflective surfaces configured to direct each planar illumination beam toward the bottom surface of the respective specimen well to improve illumination of specimens that settle or aggregate at the well bottom.

10. The system of claim 6, wherein one or more of the optical redirection elements incorporate spectral filters configured to selectively transmit or reflect light within one or more wavelength bands for fluorescence excitation.

11. The system of claim 6, wherein two or more optical redirection elements are positioned around a single specimen well, configured to direct planar illumination beams into the well from two or more directions simultaneously, thereby improving illumination uniformity and overcoming specimen-induced scattering artifacts.

12. The system of claim 6, wherein the multi-well vessel further comprises refractive optical elements integrated within the vessel structure or lid, the refractive optical elements configured to further shape or focus each planar illumination beam prior to its entry into the respective specimen well.

13. The system of claim 6, wherein each imaging unit of the multi-camera array microscope is associated with a pair of reflective surfaces, a first reflective surface configured to redirect a planar illumination beam away from the imaging unit and upward into the specimen, and a second reflective surface comprising a dichroic element configured to transmit fluorescence emission toward the imaging unit while reflecting excitation light, such that excitation light is directed away from the imaging unit and fluorescence emission is directed toward it.

14. The system of claim 1, further comprising a scanning mechanism configured to laterally displace one or more of the plurality of planar illumination beams relative to the specimen wells, thereby enabling axial scanning of each planar illumination beam through its respective specimen for three-dimensional image stack acquisition, wherein the scanning mechanism comprises one or more of: lateral displacement of the illumination sources, lateral displacement of the beam-shaping optical elements, axial displacement of the multi-camera array microscope, axial displacement of the multi-well vessel, and dynamic refocusing of individual imaging unit lenses within the multi-camera array microscope.

15. The system of claim 14, wherein axial refocusing of one or more imaging units is performed synchronously with lateral scanning of the associated planar illumination beam, such that the illuminated focal plane within the specimen remains in focus throughout the scan.

16. The system of claim 1, wherein one or more imaging units of the multi-camera array microscope are equipped with fluorescence emission filters configured to selectively detect fluorescence excited by the planar illumination beams while rejecting excitation wavelengths.

17. The system of claim 1, wherein the multi-well vessel conforms to the Society for Biomolecular Sciences (SBS) standard exterior dimensions and comprises one or more of: 12, 24, 48, 96, 384, or 1536 wells.

18. The system of claim 1, wherein the image analysis system is configured to:
(i) register a plurality of three-dimensional image stacks acquired by different imaging units;
(ii) apply digital calibration to correct for physical differences across the plurality of imaging units and their associated planar illumination beams; and
(iii) perform one or more of deconvolution, segmentation, semantic segmentation, feature detection, and three-dimensional tracking on the registered and calibrated stacks in a parallelized manner.

19. The system of claim 18, wherein the parallelized image processing is executed on a graphical processing unit.

20. The system of claim 1, wherein the specimens comprise one or more of: adherent cells, cell monolayers, cellular spheroids, organoids, embryos, and small model organisms.
